(19) United States
(12) Patent Application Publication
(10) Pub. No.: US 2026/0275713 A1
(43) Pub. Date: Sep. 17, 2026

(54) Insulating Exterior Cover Pultrusions for Framing, Plumbing, and Conduits

(71) Applicant: Robert Sherman Clarke, Boulder, CO (US)

(72) Inventor: Robert Sherman Clarke, Boulder, CO (US)

(21) Appl. No.: 19/569,389

(22) Filed: Mar. 17, 2026

Related U.S. Application Data
(60) Provisional application No. 63/773,309, filed on Mar. 17, 2025.

(51) Int. Cl. E04B 1/76; F16L 59/12

(52) U.S. Cl. CPC E04B 1/7629; F16L 59/12

(57) ABSTRACT

An insulating and architecturally enhancing exterior cover pultrusion made of a fiber reinforced polymer (FRP) which may be less than 0.19 inch in thick for capping architectural, plumbing, and electrical elements that is cheap to make, durable, and attaches to architectural elements with its own compression.

### BACKGROUND OF THE INVENTION

### 1. Field of the Invention

The present invention is in the technical field of insulating exterior covers for architectural elements such as framing, plumbing, and electrical conduits.

### 2. Description of Related Art

For more than two centuries, architectural glass has been primarily framed by metal, especially in commercial buildings. Metal provides structural integrity, attractive design freedom, and has a low visual profile, allowing more interior rooms to be lighter. However, relative to glass, metal window framing has very high thermal conductivity. We use the same metal for cooking and ice cube trays because it conducts heat and cold the fastest of any common material, but metal faming around a window transmits the outside temperature to the building interior. One solution to this problem has been to insulate the cores of the metal framing; this helps, however, the metal still transfers significant heat around the insulated core. A very significant percentage of national and international buildings also retain framing that is non-thermally broken aluminum or steel glazing.

Despite the well-known thermal inefficiencies of glass window walls (glazing) with metallic framework, glass consistently ranks as architects'most preferred exterior building material as evidenced by the dominant presence of new buildings with over eighty percent glass skins. This trend furthers the need to lower the thermal conductivity of glazing framework. A very significant percentage of the existing commercial building stock worldwide is projected to remain in place beyond 50 years, emphasizing the need to increase the overall thermal performance of presently installed glazing framework. This task of thermally and architecturally upgrading present window frames is constrained, however, by the virtual absence of products that can be both functionally and aesthetically retrofit to “cap” and insulate architectural mullions. A leading New York City energy consulting firm, analyzing the shell thermal conductivity of an essentially all glass 42 story high rise building, employed Lawrence Livermore Laboratory THERM software to estimate the aluminum framing alone to account for 27 % of the single glazed curtain wall's overall conductivity.

Additionally, the current trend in industrial design is to remove cosmetic and acoustic “drop ceilings” to improve the deep-office flow of natural light, thus exposing myriad unpainted metallic conduits and building structural elements never intended to be seen. Like metallic window framing, many of these metal or composite pipes and conduits have significant unwanted thermal or acoustic transfer. The current solution for these inefficient and unattractive structural elements is either to paint them, which takes time, or insulate them with unattractive foam.

The present invention provides a way to cheaply and quickly cap those metal frames, pipes, and conduits with insulating exterior covers in a manner that greatly reduces their thermal conductivity and is architecturally attractive through finish matching with the host frame member. Office buildings may even be enhanced in interior design through new-appearing or even altered-color mullions and conduits.

### SUMMARY

The scope of the present invention is defined solely by the appended claims and detailed description of a preferred embodiment and is not affected to any degree by the statements within this summary. The present disclosure generally involves pultruded insulating exterior covers (caps) that snap onto, or simply cover, architectural elements such as glazing architectural mullions, pipes, ventilation ducting, and electrical conduits in a fast and aesthetically pleasing manner.

### BRIEF DESCRIPTION OF THE DRAWINGS

Various embodiments are described herein with reference to the following Drawings. Not all alternatives and options are shown in the Drawings and, therefore, the Claims are not limited in scope to the content of the Drawings. Elements in the several figures are illustrated for simplicity and clarity and have not necessarily been drawn to scale.

### 1. FIGURES

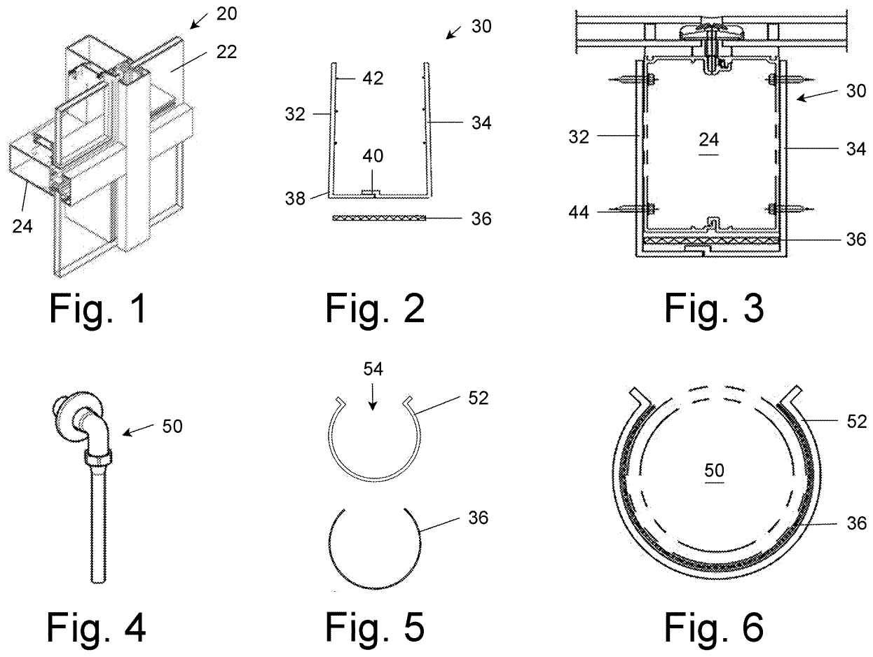

FIG. 1 illustrates a cutaway and cross-section view of a standard curtain wall assembly.

FIG. 2 illustrates a cross-section of an insulating exterior cover pultrusion with a U-shaped cross section, in accordance with an embodiment of the present disclosure. As shown, an overlapping joint may enable a given pultruded profile to be trimmed to snugly fit a wide range of existing mullion dimensions while presenting a flush face on its exterior.

FIG. 3 illustrates a cross-section of a curtain wall with an attached insulating exterior cover pultrusion with a U-shaped cross section, in accordance with an embodiment of the present disclosure.

FIG. 4 illustrates a pipe.

FIG. 5 illustrates a cross section of an insulating exterior cover pultrusion with a C-shaped cross section, in accordance with an embodiment of the present disclosure.

FIG. 6 illustrates a cross-section of a pipe with an attached insulating exterior cover pultrusion with a C-shaped cross section, in accordance with an embodiment of the present disclosure.

Corresponding reference characters indicate corresponding components throughout the several figures of the Drawings.

### 2. REFERENCES

20 Curtain wall assembly
22 Glass
24 Frame
30 Insulating exterior cover pultrusion
32 First insulating exterior cover pultrusion with an L-shaped cross section
34 Second insulating exterior cover pultrusion with an L-shaped cross section
36 Insulation
38 Insulating exterior cover pultrusion with a U-shaped cross section
40 Overlap
42 Ribs
44 Fastener
50 Pipe
52 Insulating exterior cover pultrusion with a C-shaped cross section
54 Gap

### DETAILED DESCRIPTION

The following description is not to be taken in a limiting sense but is made merely for the purpose of describing the general principles of exemplary embodiments, no limitation of the scope of the invention is thereby intended. The phrases: “in one embodiment,” “in an embodiment,” and similar language throughout this specification may, but do not necessarily, all refer to the same embodiment. The phrases “at least one,” “one or more,” and “and/or” are open-ended expressions that are both conjunctive and disjunctive in operation. The terms “a” or “an” entity refers to one or more of that entity. As such, the terms “a” (or “an”), “one or more” and “at least one” can be used interchangeably herein. Further, all numbers expressing dimensions, physical characteristics, and so forth, used in the specification and claims are to be understood as being modified in all instances by the term “about”.

Regarding the illustrations, as used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing or figure faces the reader. Similarly, the terms “inwardly” and “outwardly” generally refer to the orientation of a surface relative to its axis of elongation, or axis of rotation, as appropriate.

For the purposes of promoting an understanding of the principles of the present invention, reference will now be made to the embodiments illustrated in the drawings and specific language will be used to describe the same.

FIG. 1 illustrates a cutaway and cross-section view of a standard curtain wall assembly (20), which has glass (22), and a frame (24). The frame (24) could be metal or non-metal; such as wood, concrete, plastic, fiberglass, drywall, or any other building material; it could be structural or non-structural; and it could be interior or exterior; that's unimportant as the present invention can be applied to all possible combinations of those elements. Likewise, the frame (24) could simply be a metallic conduit for ventilation, electrical conduit, plumbing, for aesthetics, or for any purpose so long as it is roughly a rectangular prism or cylindrical prism. In the preferred embodiment of the invention, which is used for insulation as well as aesthetic purposes, the frame (24) will typically be metallic. It should be noted that despite having greatest benefits when applied to structural elements with undesirable thermal characteristics, this invention can be applied to objects of many physical shapes.

FIG. 2 illustrates a cross-section of an insulating exterior cover pultrusion (30) also called a cap. A cap is generally sized in height, width, and length to fit tightly over a frame (24) element. The caps can be premade to fit exactly over the element, made in several pieces to fit, or cut to fit. In the pictured embodiment the cap may comprise one or more of the following three elements: a first insulating exterior cover pultrusion with an L-shaped cross section (32), a second insulating exterior cover pultrusion with an L-shaped cross section (34), and insulation (36). The first insulating exterior cover pultrusion with an L-shaped cross section (32) and the second insulating exterior cover pultrusion with an L-shaped cross section (34) may simply be all one unified continuous insulating exterior cover pultrusion with a U-shaped cross section (38). Alternatively, the first L-shaped cross section pultrusion (32) and the second L-shaped cross section pultrusion (34) may have an overlap (40) that allows for caps of different sizes to be mixed and matched to fit the desired usage. The overlap feature may further comprise either a permanent or detachable coupling to hold the caps together.

Insulation (36) may be inserted between the insulated exterior cover pultrusion (30) and an architectural element to improve the overall fit and insulation of the cap. The insulation may be made of any material suitable for its purpose, ideally something with low thermal conductivity and light, such as aerogel.

Said insulating exterior cover pultrusion with a U-shaped cross section (38) may be formed such that the internal angles are acute, thereby creating tension in the cap when opened and placed over an architectural element, thereby allowing the cap to be installed with a pressure-fit extremely quickly. Additionally, the insulating exterior cover pultrusion (30) may have internal ribs (42) that create air gaps between the exterior cover and the architectural element, providing further insulation. The ribs may also assist in pressure fit of the cap to the element.

The use of two U-shaped pultrusions (38), or four L-shaped pultrusions may be used to entirely encapsulate four sides of a hexahedral polyhedron. It will also be appreciated that the illustrated design is for capping rectangular prisms, but the insulating exterior cover pultrusions need not have right angles, and any number of L-shaped exterior covers could be used to cover any possible geometric shape or surface. It just happens to be that most structural elements are made with right angles.

Additionally, the coloring of the caps can be matched exactly to the architectural element it is applied to, making the appearance of the caps virtually identical to the architectural element. Additionally, it may comprise water based painted exterior surfaces certifiable to the highest prevailing industry standards for safety and longevity. Such paint may also protect the caps from degradation from UV light.

The insulating exterior cover pultrusions (30) may simply be used to improve the appearance of whatever surface it covers; but, when applied to materials with high thermal conduction, such as metal, the insulating exterior cover pultrusion (30) provides vital insulation. By insulating the most conductive parts of a building, the caps greatly improve the energy efficiency of the structures they are applied to. The insulating exterior cover pultrusions (30) can be made of any material suitable to its purpose; ideally it should also meet or exceed the strictest interior air-quality standards. In a preferred embodiment, the exterior cover (30) comprises a substrate fiber reinforced polymer (FRP) manufacture utilizing high-volume, low-cost pultrusion, and high-volume painting to which they are applied.

Fiber reinforced polymer (FRP) is ideal because it is impervious to moisture, is not subject to warpage or corrosion, and allows for less than 1/500^{th} the heat transfer of aluminum with an extremely low thermal conductivity of below 0.35W/(m. K). Additionally, the cap's exterior and interior may be painted to improve its thermal insulation, said coating may further reduce the surface emissivity of the cap to below 0.30.

In the preferred embodiment, the (FRP) insulating exterior cover pultrusion (30) comprises one or more of the following material characteristics: a cap with a coefficient of linear expansion of less than 12 micrometers/m° C.; a flexural stiffness of greater than 10 in.-lbs/in, (1133 Nmm/mm) per unit width; a thickness of less than 0.19 inches; and/or a Barcol Hardness greater than 35.

FIG. 3 illustrates a cross-section of a curtain wall showing an interior vertical metallic mullion with an attached insulating exterior cover pultrusion (30), in accordance with an embodiment of the present disclosure. The exterior cover may be pressure fit, glued, attached with fasteners (44), or with any other common form of attachment.

FIG. 4 illustrates a pipe (50).

FIG. 5 illustrates an insulating exterior cover pultrusion (cap) with a C-shaped cross section (52) and insulation (36). The C-shaped cross section pultrusion (52) and insulation (36) is mostly cylindrical and has a gap (54) so that said cap can pressure fit over plumbing, electrical conduits, posts, poles, and other cylindrical architectural elements. FIG. 6 illustrates a cross-section of a pipe with said C-shaped cross section pultrusion attached. Given this shape of cap (52) it would likely not need any other form of fastener to stay in place.

The material properties of said insulating exterior cover pultrusion with a C-shaped cross section (52) are the same as those noted above for the L and U-shaped caps.

The scope of the present disclosure fully encompasses other embodiments which may become obvious to those skilled in the art, and is to be limited, accordingly, by nothing other than the appended claims. All structural and functional equivalents to the elements of the above-described preferred embodiment and additional embodiments as regarded by those of ordinary skill in the art are hereby expressly incorporated by reference and are intended to be encompassed by the present claims.

1. An insulating exterior cover pultrusion, wherein said pultrusion is sized to tightly fit and cover part of an object, thereby insulating it.

2. The insulating exterior cover pultrusion of claim 1, further comprising additional insulation inserted onto an interior surface of said insulating exterior cover pultrusion; wherein said additional insulation adds to the insulation of the exterior cover pultrusion and both insulate said object.

3. The insulating exterior cover pultrusion of claim 1, wherein said insulating exterior cover pultrusion pressure fits onto said object.

4. The insulating exterior cover pultrusion of claim 1, wherein said insulating exterior cover pultrusion has internal ribs that create airgaps between said insulating exterior cover pultrusion and said object, further insulating said object and assisting in pressure fitting said insulating exterior cover pultrusion to said object.

5. The insulating exterior cover pultrusion of claim 1, wherein said insulating exterior cover is colored to match the color of the object that it covers.

6. The insulating exterior cover pultrusion of claim 1, wherein said insulating exterior cover is UV protected.

7. The insulating exterior cover pultrusion of claim 1, wherein said insulating exterior cover is painted and said paint adds insulation.

8. The insulating exterior cover pultrusion of claim 1, wherein said object is metal building framing and said insulating exterior cover pultrusion prevent thermal transfer from an exterior building environment to an interior environment and vice versa.

9. The insulating exterior cover pultrusion of claim 1, wherein said insulating exterior cover is fiber reinforced polymer.

10. The insulating exterior cover pultrusion of claim 1, wherein said insulating exterior cover pultrusion has a U-shaped cross-section; and wherein said pultrusion cross-section is sized to fit a cross-section of said object.

11. The insulating exterior cover pultrusion of claim 10, wherein said insulating exterior cover pultrusion pressure fits onto said object.

12. The insulating exterior cover pultrusion of claim 10, further comprising:
a second insulating exterior cover pultrusion with a U-shaped cross-section; and
wherein said first and said second insulating exterior cover pultrusions with U-shaped cross-sections can be combined to create a fully enclosed quadrilateral cross section that is sized to tightly fit around said object when said object has four exposed sides.

13. The insulating exterior cover pultrusion of claim 1, wherein said insulating exterior cover pultrusion has a C-shaped cross-section; and wherein said pultrusion cross-section is sized to fit the cross-section of said object.

14. The insulating exterior cover pultrusion of claim 13, wherein said insulating exterior cover pultrusion pressure fits onto said object.

15. The insulating exterior cover pultrusion of claim 13, wherein said object is a pipe.

16. The insulating exterior cover pultrusion of claim 1, further comprising:
a first insulating exterior cover pultrusion with an L-shaped cross section;
a second insulating exterior cover pultrusion with an L-shaped cross section; and
wherein said first and said second L-shaped pultrusions, when fit together, form a U-shaped cross-section; and wherein said pultrusions'cross-sections are sized to tightly fit an object with three exposed sides.

17. The insulating exterior cover pultrusions of claim 16, further comprising:
additional insulating exterior cover pultrusions with L-shaped cross-sections; and
wherein said additional insulating exterior cover pultrusions with L-shaped cross-sections can be combined to tightly fit exposed sides of said object.

18. The insulating exterior cover pultrusion of claim 16, wherein said first and said second L-shaped pultrusions have an overlap.

19. The insulating exterior cover pultrusion of claim 18, wherein said overlap comprises either a permanent or detachable coupling to hold said pultrusions together.
